(19) United States
(12) Patent Application Publication
(10) Pub. No.: US 2019/0324778 A1
(43) Pub. Date: Oct. 24, 2019

(54) GENERATING CONTEXTUAL HELP

(71) Applicant: ADOBE INC., San Jose, CA (US)

(72) Inventors: SUDEEP RANJAN BHOWMICK, SUNNYVALE, CA (US); PETER RAYMOND FRANSEN, SOQUEL, CA (US)

(21) Appl. No.: 15/956,670

(22) Filed: Apr. 18, 2018

(51) Int. Cl. G06F 9/451; G06F 11/34; H04L 12/24

(52) U.S. Cl. CPC G06F 9/453; H04L 41/5074; G06F 11/3438

(57) ABSTRACT

Methods and systems are provided for providing help regarding an in-app issue with an application using a contextual help system. Help can be provided automatically based on an analysis of in-app events leading up to the indication for help with the in-app issue. Automatic help can be provided in the form of help content determined to be likely to resolve the in-app issue. When no help content is determined to be likely to resolve the issue, the in-app events can be converted into a human-readable form and sent to a live help desk for use in resolving the issue. In this way, in-app issues can be resolved based on evaluations of the in-app event leading up the occurrence of the issue.

### BACKGROUND

Owners of applications often provide help documentation accessible to users to encourage the users to lookup help solutions using the documentation. To this end, users can access the help documentation rather than calling into a help line or walking into a store. Successful access of applicable documentation by an application user ensures that a company with slim monthly income margins for its customers is able to maintain those margins (e.g., margins are not maintained when a customer contacts live support due to costs associated with paying for live support). Failing to have help documentation that adequately solves a user's problem often results in frustration of the user and time, effort, and money being expended by the application owner to help the user.

Conventional methods for providing help documentation generally rely on a user manually selecting an applicable document to review. Other methods can be based on a search term entered into a “help” section. Such conventional methods are successful when applicable help content is found and/or provided to a user such that the user does not need to contact live support to solve an issue with an application. However, in many cases, the help content provided is incorrect or simply does not exist. Accordingly, such instances often result in users accessing live support (e.g., via phone or in-person in a store).

### SUMMARY

Embodiments of the present disclosure are directed towards generating contextual help based on in-app actions. In accordance with embodiments, such contextual help can be provided in real time to an application user upon encountering difficulties with an application (e.g., functionality, navigation, interaction, etc.). Advantageously, such a contextual help system is capable of generating and/or providing help content predicted to be applicable to the user based on the user's in-app actions prior to requesting help. In this way, help content provided to the user is likely to resolve the issue(s) that prompted the use to request help. As such, the user is less likely to require a live support person (e.g., via a customer support or in-person in a store).

A contextual help system can provide suggested help content by analyzing a user's in-app actions to determine which help content is likely to resolve the user's issue(s). Successful production of applicable help content is likely to decrease reliance on live support.

### BRIEF DESCRIPTION OF THE DRAWINGS

FIG. 1A depicts an example configuration of an operating environment in which some implementations of the present disclosure can be employed, in accordance with various embodiments.

FIG. 1B depicts an example configuration of an operating environment in which some implementations of the present disclosure can be employed, in accordance with various embodiments.

FIG. 2 depicts an example configuration of an operating environment in which some implementations of the present disclosure can be employed, in accordance with various embodiments of the present disclosure.

FIG. 3 an illustrative environment for providing contextual help to users based on in-app event history leading up to request/indication for help, in accordance with embodiments of the present disclosure.

FIG. 4 illustrates a process flow depicting an example of a request/indication for help with an in-app issue, help provided based on an analysis of in-app history using a contextual help system, in accordance with embodiments of the present disclosure.

FIG. 5 illustrates a process flow depicting an example a contextual help system receiving a request for help with an in-app issue and providing help based on in-app history, in accordance with embodiments of the present invention.

FIG. 6 is a block diagram of an example computing device in which embodiments of the present disclosure may be employed.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various terms are used throughout this description. Definitions of some terms are included below to provide a clearer understanding of the ideas disclosed herein:

The term “help content” generally refers to content provided to a user that is likely to resolve an in-app issue with an application. Help content can include troubleshooting documentation, recommended links within an application, or any other type of contextually-based help that can be provided to a user.

The term “in-app history” generally refers a history of a user's interactions with a particular application. For instance a user's historical record of what the user has done within an application. An in-app history can be a snapshot of the event stream leading up to, and possibly including, a spot where the user indicates help.

The term “events” generally refers interactions by a user with an application. Events can include, for example, scrolling up/down, clicking on a button, time spent in an area of the application, input information, etc.

The term “in-app issue” generally refers to any issue with an application causing a user to seek help or stop using the application. For instance, issues can be regarding the use and/or functionality of an application.

The term “application” generally refers a collection of content that is suitable for display as a mobile application and/or website via a monitor or a mobile device.

When interacting with applications, users can run into issues prompting them to seek help or stop using an application. In some cases, such issues can lead to a user abandoning use of a particular application due to frustration. To help resolve issues with an application, users can access tech support offered by application owners.

Application owners offer a variety of conventional help and/or support options to help application users. Such conventional help options often include static tutorials, static overlay screens showing positions and optional descriptions of action areas of the application, Frequently Asked Question (FAQ) pages, and web-based help. When such computerized help options fail, conventional help can further include direct interaction with a live support person. With the advancement of technology, help tools have been created in an attempt to produce help topics that are more relevant to an issue the user needs help with. Such help tools, however, are generally limited to running user-input search queries using search text fields (e.g., allowing a user to specify a natural language query and showing corresponding help topics in response). These help systems, however, do not allow for the system to proactively provide solutions to users when detecting a user has issues with an application. Further, such systems are not capable of adding to its knowledge base when existing help content does not solve a particular issue a user is facing or learning that a previous solution no longer resolves issues with the application. For instance, when one user runs into an issue and hits a dead end with the system, if the same issue occurs again for another user, the system will most likely end up in the same dead end again because the system cannot learn and/or add to the possible solutions. As such, existing technologies are generally deficient in providing contextual help while learning based on previous help content known to resolve previous in-app issues.

Accordingly, embodiments of the present disclosure are directed to generating contextual help for a user based on past in-app actions. In particular, and as described herein, data collected from user interaction(s) with an application can be used to provide users with help (e.g., help content and/or in-app suggestions). If automated help cannot be provided, the system can pass a user's history of application events to a live support person. Upon resolution of the user's issue, the events and resolution can be used for the system to learn a new automated help path within the system. Such a self-learning system can reduce the amount of time and effort spent addressing application user issues. Further, such a system can learn issues based on various versions of an application (e.g., version 10.1 of an application may have different issues and solutions as compared to version 12.3 of the same application).

In this regard, help can be provided to users using a contextual help system capable of learning how to address a user's in-app issue(s) deduced using the user's in-app actions leading up to the occurrence of the issue(s). Help can be provided automatically by determining whether help content is associated with the user's in-app history. Help content generally refers to troubleshooting documentation, recommended links within an application, or any other type of contextually-based help that can be provided to a user. In situations where the system is not able to automatically provide help content, the system can pass the user and user's in-app history of events to a live support desk. In-app history can be taken from a user's interactions with a particular application (e.g., a user's historical record of what the user has done within an application—a snapshot of the event stream leading up to, and possibly including, the spot where the user indicates help).

Contextual help can be provided to a user by analyzing similarity of the user's in-app history with user interactions linked to a known solution (e.g., help content). Machine learning can be used to determine such similarity by analyzing past in-app history and solutions provided to users, and incorporating user feedback on the accuracy and/or usefulness of provided help content. Alternatively, or in addition, solutions provided by a live support technician can be used to train a system based on the in-app history of the user inquiring for help. In this way, contextual help can be provided to a user for an in-app issue based on the user's in-app history leading up to the request for help in a manner that decreases the need for live-support as the system learns to deduce solutions based on the in-app history.

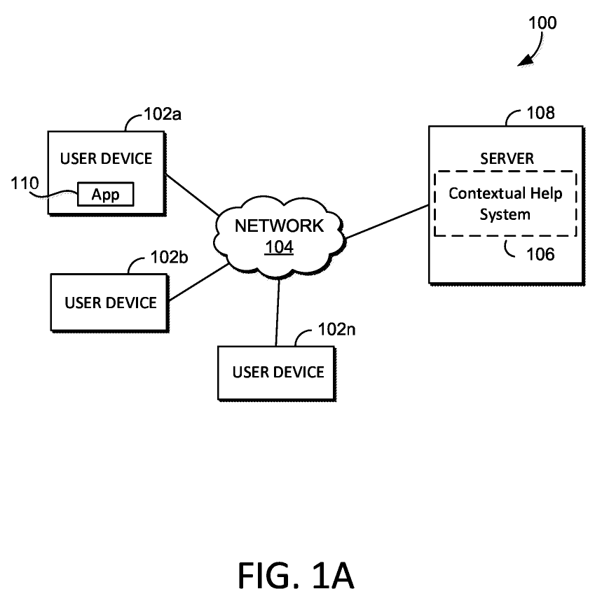

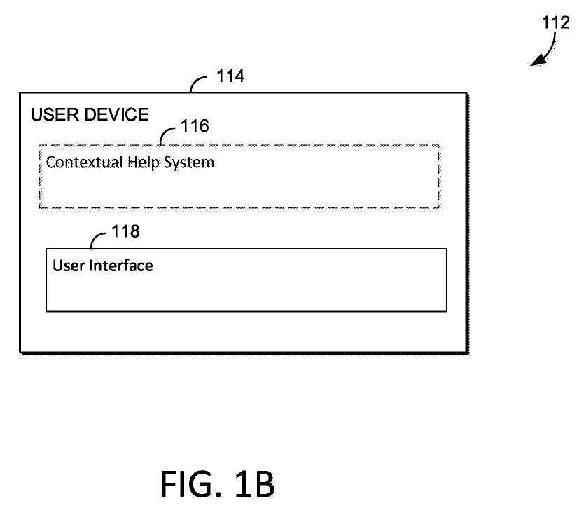

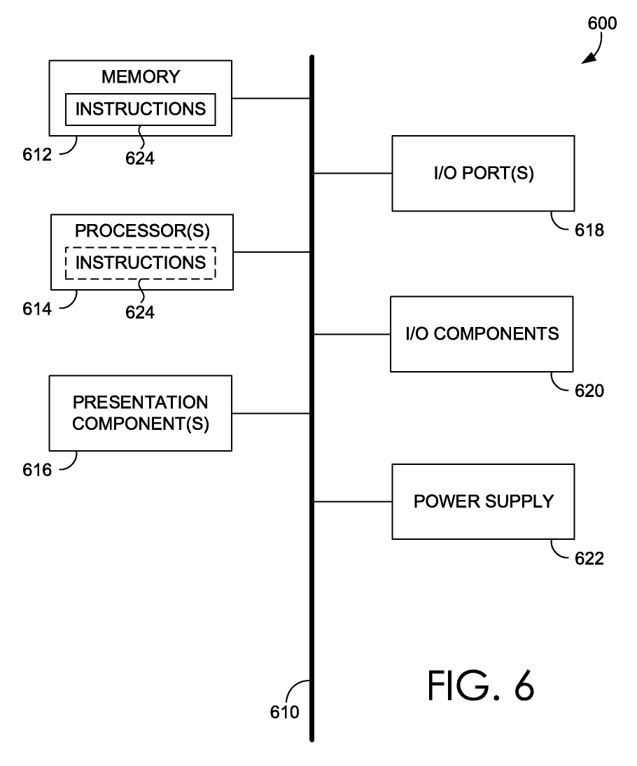

FIG. 1 depicts an example configuration of an operating environment in which some implementations of the present disclosure can be employed, in accordance with various embodiments. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory as further described with reference to FIG. 6.

It should be understood that operating environment 100 shown in FIG. 1 is an example of one suitable operating environment. Among other components not shown, operating environment 100 includes a number of user devices, such as user devices 102a and 102b through 102n, network 104, and server(s) 108. Each of the components shown in FIG. 1 may be implemented via any type of computing device, such as one or more of computing device 600 described in connection to FIG. 6, for example. These components may communicate with each other via network 104, which may be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, and/or one or more private networks. Where network 104 includes a wireless telecommunications network, components such as a base station, a communications tower, or even access points (as well as other components) may provide wireless connectivity. Networking environments are commonplace in offices, enterprise-wide computer networks, intranets, and the Internet. Accordingly, network 104 is not described in significant detail.

It should be understood that any number of user devices, servers, and other components may be employed within operating environment 100 within the scope of the present disclosure. Each may comprise a single device or multiple devices cooperating in a distributed environment.

User devices 102a through 102n can be any type of computing device capable of being operated by a user. For example, in some implementations, user devices 102a through 102n are the type of computing device described in relation to FIG. 6. By way of example and not limitation, a user device may be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user devices can include one or more processors, and one or more computer-readable media. The computer-readable media may include computer-readable instructions executable by the one or more processors. The instructions may be embodied by one or more applications, such as application 110 shown in FIG. 1. Application 110 is referred to as a single application for simplicity, but its functionality can be embodied by one or more applications in practice. As indicated above, the other user devices can include one or more applications similar to application 110.

The application(s) may generally be any application capable of facilitating the exchange of information between the user devices and the server(s) 108 in carrying out determining and providing appropriate contextual help for resolving application issues. In some implementations, the application(s) comprises a web application, which can run in a web browser, and could be hosted at least partially on the server-side of environment 100. In addition, or instead, the application(s) can comprise a dedicated application. In some cases, the application is integrated into the operating system (e.g., as a service). It is therefore contemplated herein that “application” be interpreted broadly.

In accordance with embodiments herein, the application 110 can relate to a specific company (e.g., a company's mobile application for banking, cell phone bill payment, buying movie tickets, etc.). In particular, a user can interact with the application, for example, using touch functionality on a device. Upon running into issues with the application, a user can request help and/or an indication for help can be automatically triggered. Contextual help can be provided to the user, via the application, based on a history of in-app interactions by the user leading up to the request/indication for help. Such a history of in-app interactions can be stored in a data store accessible by a network or stored locally at the user device 102a. For instance, based on the user's in-app history, help content can be determined and provided to the user via the user device 102a. In this regard, the help content can be displayed via a display screen of the user device. Additionally, if no help content can be deduced as helpful/applicable based on the user's in-app history, the user can be connected with a live support technician.

As described herein, server 108 can facilitate analyzing a user's in-app history, using contextual help system 106, to determine whether any help content exist that are likely to resolve the user's application issue(s). Server 108 can also facilitate directing a user and the user's in-app history to a live support desk when no help content appears likely to resolve the user's issue(s). Server 108 includes one or more processors, and one or more computer-readable media. The computer-readable media includes computer-readable instructions executable by the one or more processors. The instructions may optionally implement one or more components of contextual help system 106, described in additional detail below.

Contextual help system 106 can include a trained and operable neural network system for analyzing user in-app history and determining help content likely to help resolve user issues. Such a neural network system can be comprised of one or more neural networks trained to generate a designated output (e.g., determining contextual help content using in-app history). The neural network system can be dynamically updated upon iterations of providing contextual help to a user. Dynamic updating can be based on, for example, feedback from a user on the applicability/helpfulness of a provided document and/or inputting of a solution as determined by a live support desk in response to a user's in-app history.

For cloud-based implementations, the instructions on server 108 may implement one or more components of contextual help system 106, and application 110 may be utilized by a user to interface with the functionality implemented on server(s) 108. In some cases, application 110 comprises a web browser. In other cases, server 108 may not be required. For example, the components of contextual help system 106 may be implemented completely on a user device, such as user device 102a. In this case, contextual help system 106 may be embodied at least partially by the instructions corresponding to application 110.

Thus, it should be appreciated that contextual help system 106 may be provided via multiple devices arranged in a distributed environment that collectively provide the functionality described herein. Additionally, other components not shown may also be included within the distributed environment. In addition, or instead, contextual help system 106 can be integrated, at least partially, into a user device, such as user device 102a. Furthermore, contextual help system 106 may at least partially be embodied as a cloud computing service.

Referring to FIG. 1B, aspects of an illustrative contextual help system are shown, in accordance with various embodiments of the present disclosure. FIG. 1B depicts a user device 114, in accordance with an example embodiment, configured to allow for determining and providing appropriate contextual help for resolving application issues. The user device 114 may be the same or similar to the user device 102a-102n and may be configured to support the contextual help system 116 (as a standalone or networked device). For example, the user device 114 may store and execute software/instructions to facilitate interactions between a user and the contextual help system 116 via the user interface 118 of the user device.

A user device can be utilized by a user to facilitate interactions with an application. In particular, a user can indicate when help is requested regarding use and/or functionality of the application. Help content can be provided to the user based on in-app history leading up to a request/indication for help. The user interface may facilitate viewing of the help content. Further, when no help content can be found applicable to the user's issue, as based on the user's in-app history, the user interface may be utilized to connect the user with a live support desk (e.g., real-time support and/or an offline queue of support requests).

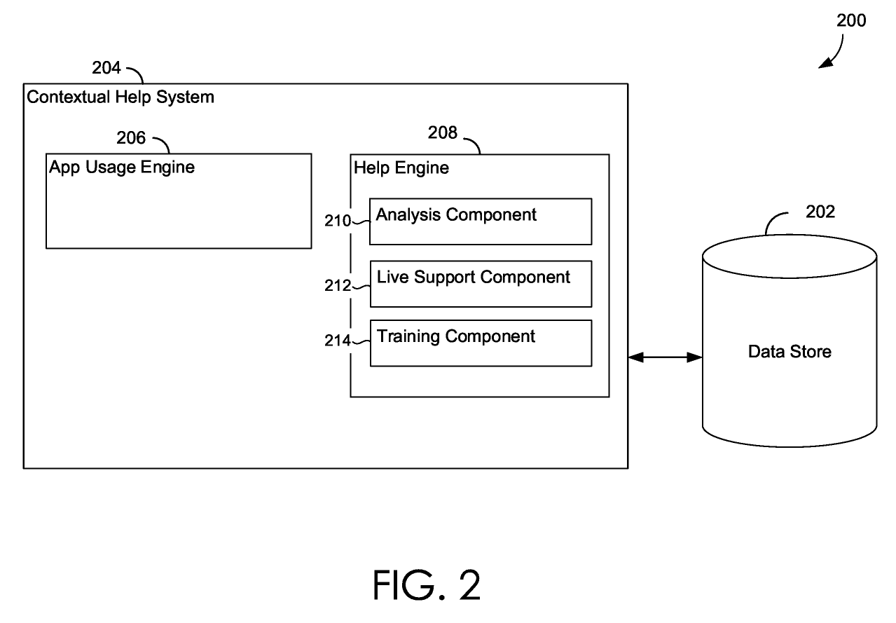

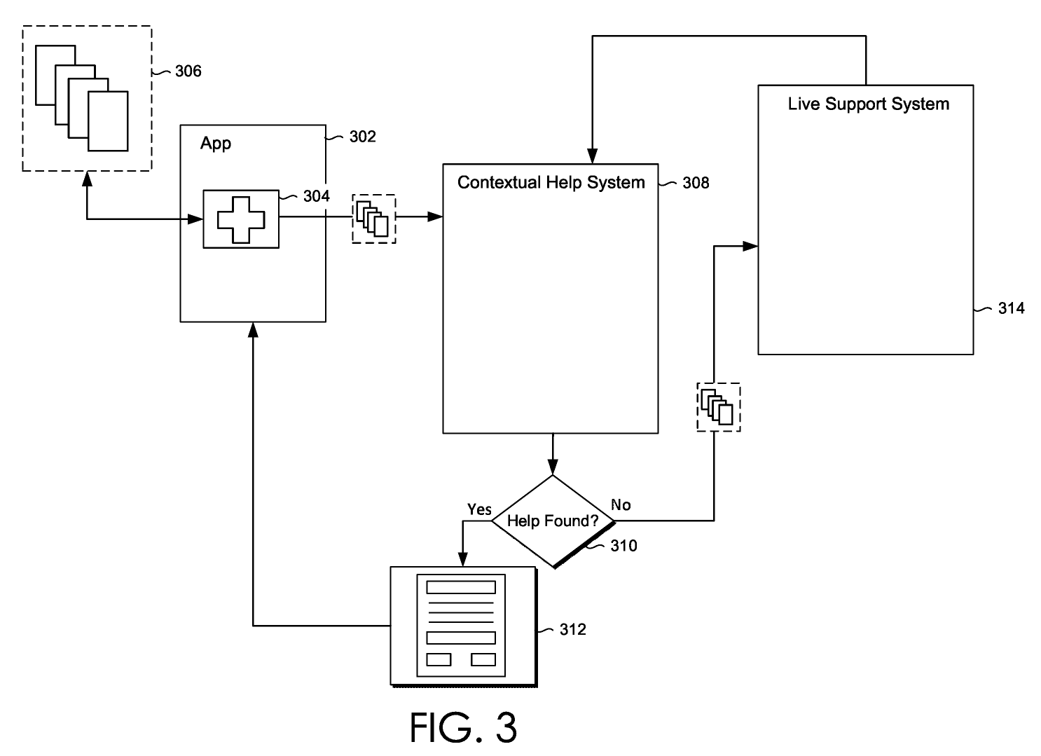

Referring to FIG. 2, aspects of an illustrative environment 200 are shown, in accordance with various embodiments of the present disclosure. Contextual help system 204 includes app usage engine 206 and help engine 208. The foregoing engines of contextual help system 204 can be implemented, for example, in operating environment 100 of FIG. 1A and/or operating environment 112 of FIG. 1B. In particular, those engines may be integrated into any suitable combination of user devices 102a and 102b through 102n and server(s) 106 and/or user device 114. While the various engines are depicted as separate engines, it should be appreciated that a single engine can perform the functionality of all engines. Additionally, in implementations, the functionality of the engines can be performed using additional engines and/or components. Further, it should be appreciated that the functionality of the engines can be provided by a system separate from the contextual help system (e.g., live support system 314 as discussed with reference to FIG. 3).

As shown, a contextual help system can operate in conjunction with data store 202. Data store 202 can store computer instructions (e.g., software program instructions, routines, or services), data, and/or models used in embodiments described herein. In some implementations, data store 202 can store information or data received via the various engines and/or components of contextual help system 204 and provide the engines and/or components with access to that information or data, as needed. Although depicted as a single component, data store 202 may be embodied as one or more data stores. Further, the information in data store 202 may be distributed in any suitable manner across one or more data stores for storage (which may be hosted externally). In embodiments, data stored in data store 202 can include in-app history for a user(s), help content, and/or training data. Data can be input into data store 202 from a device, such as from a server or a user device, where the device can be remote.

In embodiments, data stored in data store 202 can include training data. Training data generally refers to data used to train a neural network system, or portion thereof. As such, training data can include in-app history, in-app user issues, help content/solutions likely to resolve in-app user issues, and relationships therebetween. In some cases, data can be received by contextual help system 204 from user devices (e.g., a user's in-app history, feedback regarding the applicability of help content/how successful the provided help content was in resolving a user's in-app issue). In other cases, data can be received from one or more data stores in the cloud (e.g., help content determined to likely resolve a user's in-app issue, a solution determined by a live support desk).

Data store 202 can also be used to store a neural network system during training and/or upon completion of training. Such a neural network system can be comprised of one or more neural networks used to determine contextual help for a user issue.

Contextual help system 204 can generally be used to determine and provide appropriate contextual help likely to resolve a user's application issues. Specifically, the contextual help system can be trained to analyze a user's in-app history to determine whether help content is likely to resolve the user's issues with an application. In accordance with embodiments described herein, the contextual help system can provide such help content to a user. Further, the contextual help system can connect a user to a live support desk when the system determines there is not help content likely to resolve the user's issues with the application.

App usage engine 206 can be used to collect and/or process a user's in-app history. As depicted in FIG. 2, app usage engine 206 can interact with help engine 208 to determine whether help content exists that is likely to resolve a user's issues with an application. In-app history can include analytics event data collected by an analytics system that defines user behavior, information about user visits, user interactions, etc. In-app history can be stored as a historical record of user interactions with an application representing a snapshot of the event stream leading up to, and possibly including, the instance in which the user has an issue and requests/indicates the need for help. The app usage engine can collect in-app history to store for any length of time (e.g., daily, monthly, yearly, etc.). In-app history can be sorted by time so that the usage data can be analyzed for causality/temporal relationships between events.

When help is requested/indicated by a user, the app usage engine can package the appropriate in-app history of events for use in determining any applicable help content to provide to the user. Appropriate in-app history can be based on time, an amount of events, type of events, etc. App usage engine can also store user consent to gather such data related to in-app usage.

Help engine 208 can be used to provide help to an application user to resolve user's issues with an application. As depicted, help engine 208 includes analysis component 210, live service component 212, and training component 214. The foregoing components of help engine 208 can be implemented, for example, in operating environment 100 of FIG. 1A and/or operating environment 112 of FIG. 1B. In particular, those components may be integrated into any suitable combination of user devices 102a and 102b through 102n and server(s) 106 and/or user device 114. While the various components are depicted as separate components, it should be appreciated that a single component can perform the functionality of all components. Additionally, in implementations, the functionality of the components can be performed using additional components and/or engines. Further, it should be appreciated that the functionality of the components can be provided by a system separate from the contextual help system.

Analysis component 210 can be used to determine whether help content exits that is likely to resolve a user's issues with an application based on an analysis of the user's in-app history. The analysis component can receive in-app history of events leading up to, and, in some embodiments, including, the event of a user requesting/indicating for help. Such an in-app history can be analyzed to determine if there is pre-existing help content and/or document location associated with a similar event history. A similar event history generally relates to in-app events of a current user and the same and/or different user's in-app interactions with the same application exceeding a predefined threshold of similar and/or same events. The threshold of similarity can be set based on how closely a user's in-app history mirrors an in-app history linked to particular help content (e.g., same/similar events, event order, duration, etc.). Upon determining a similar event history, help content that successfully resolved a previous user's in-app issue(s) for a previous issue can be provided to the particular user.

An analysis of the user's in-app history can be performed automatically via an analysis component using, in part or in whole, a trained neural network. The training of such a system if further discussed below with reference to training component 214. The analysis can be automatically triggered by a request/indication for help such that the in-app history is automatically obtained and analyzed via a trained neural network to determine help content likely to resolve the user's in-app issues. In this way, when the analysis component determines that particular help content is applicable, based on the analysis of a user's in-app history, the help content can be provided to the user.

When the analysis component determines that there are not any help content likely to solve the user's in-app issues, the user can be passed to a live support desk. Live support component 212 can be used to provide support to a user when help content cannot be determined that are likely to resolve the user's in-app issues. The live support component can receive a user's in-app history of events leading up to, and, in some embodiments, including, the event of a user requesting/indicating for help. In embodiments, the live support component can process the in-app history of events, using, for example, inverse language processing, to turn the in-app history into a human readable sentence and/or paragraph. This human readable sentence/paragraph can be provided to a live support person connected to the user such that the support person has a better idea of how to resolve the user's in-app issues. The live support person can resolve the user's in-app issues by providing a known or unknown solution based on the in-app history. A known solution can include preexisting help content in the contextual help system that for some reason was not automatically provided to the user via the automated system. This can occur when there is an incorrect mapping for an in-app history, or no mapping at all, to the help content. An unknown solution can be a solution to a previously unknown issue or an issue not adequately addressed by help content in the contextual help system at the time the issue occurred.

Training component 214 can supervise the training of a contextual help system. Training can be defined as an initial training of the system as well as updates made to the system. Such a system can include one or more neural networks. The contextual help system can be trained to analyze a user's in-app history and provide help content likely to resolve the user's in-app issues. Training can include generating correlations between particular event sequences and known solutions in the contextual help system (e.g., help content likely to solve the issue indicated by an event sequence). Further, feedback from a user on the applicability/helpfulness of provided help content and/or solution can be used to train and/or update the system.

In an embodiment, upon resolving a user's issues with an application, training component 214 can be used to dynamically train/update the system to incorporate the solution used to resolve the user's issues. Such training can be a new mapping (e.g., pathway in the neural network) of an event sequence to help content/solution or reinforcing a previous mapping (e.g., an existing pathway in the neural network) in the system. An input/output of the contextual help system can be used to train the system along with user feedback of the output. For instance, the input can be a user's in-app history, the output can be an indication of help content the system determines is likely to resolve the user's in-app issues based on an analysis of the in-app history, and feedback can be from the user indicating the usefulness of the help content in resolving the user's issues. Training a contextual help system in this manner provides positive feedback to strengthen the correlations in the system between event sequences and help content and negative feedback to weaken the correlations between event sequences and help content. Advantageously, such training allows for a continually updated intelligent system that changes along with modifications to an application, fluctuations in user knowledge, etc.

The system can also be trained by inputting a solution as determined by a live support desk in response to a user's in-app history. When a live support person helping a user determines there is help content in the system that was not provided due to incorrect mapping, the system can be trained to automatically provide the help content to a user in the future based on the analysis of the user's in-app history being similar to that of the previous user. When there is no help content in the system that are likely to resolve a user's issues with the application, a live support person can document the list of steps/the determined solution to the user's issue. Such documentation can be written up in a manner that can be fed back into the contextual help system such that the system can learn to automatically provide that help content when users run into a similar problem.

Adjusting the neutral network(s) of the contextual help system during training/updates can be accomplished by changing at least one node parameter of the network. The network can comprise a plurality of interconnected nodes with a parameter, or weight, associated with each node. Each node can receive inputs from multiple other nodes and can activate based on the combination of all these inputs, for example, when the sum of the input signals is above a threshold. The parameter can amplify or dampen the input signals. For example, a parameter could be a value between 0 and 1. The inputs from each node can be weighted by a parameter, or in other words, multiplied by the parameter, prior to being summed. In this way, the parameters can control the strength of the connection between each node and the subsequent node. For example, for a given node, a first parameter can provide more weight to an input from a first node, while a second parameter can provide less weight to an input from a second node. As a result, the parameters strengthen the connection to the first node, making it more likely that a signal from the first node will cause the given node to activate, while it becomes less likely that inputs from the second node will cause activation.

Advantageously, such a self-learning contextual help system can reduce the amount of time and effort spent addressing application user issues. Using machine learning in a contextual help system allows the system to learn issues based on various iterations of an application (e.g., version 10.1 of an application may have different issues and solutions as compared to version 12.3 of the same application). In this manner, the neural network knowledgebase has a built-in decay of neurons so the system learns to no longer provide solutions indicated as inaccurate. Decay can occur for a variety of reasons, such as, for example, experience of help desk individuals can change and evolve as application issues change and get resolved and/or general public understanding of technology and technology itself is constantly changing (e.g., recommendations valid for an iPhone® 8 can differ or be inaccurate for an iPhone® X).

FIG. 3 depicts an illustrative environment for providing contextual help to users based on in-app event history leading up to request/indication for help, in accordance with embodiments of the present disclosure. As illustrated, application 302 is shown with help 304. It should be appreciated that, help can be a help button or any a request/indication for help. In embodiments, help can be a request/indication triggered automatically by a contextual help system detecting a user issue (e.g., an indication for help can occur when a user has ceased to interact with an application following a particular sequence of events).

In-app history 306 can be collected and stored for application 302. In-app history can include data collected regarding a user's interactions with the application. Each interaction by the user, no matter how minor, can be tracked as an in-app event. Events can include, for example, scrolling up/down, clicking on a button, time spent in an area of the application, input information, etc. In-app history can be stored as a record of what a user has done within the application. Tracking and saving the event stream can provide a snapshot of what occurred leading up to, and possibly including, the instance in which the user encounters an in-app issue and requests/indicates the need for help. In-app history can be stored for any length of time (e.g., daily, monthly, yearly, etc.). In-app history can also be sorted by time prior to storage so that the usage data can be analyzed for causality/temporal relationships between events. Such a sorted in-app history can be stored in a data structure that can be referenced upon a request/indication for help. The number and type of events or actions performed by a user can include an amount of time for each event or action such that time can be used an analysis factor as well. For example, assume there are five events leading up to a request/indication for help and a user spends three minutes on the second event and five minutes on the fourth event. When the user gets to event five and encounters an in-app issue, a different solution should be provided to the user than if the user encounters the in-app issue during event two for 30 seconds and not on any of the other events. In this way, help content provided to a user can be based on a user's event history and related data (e.g., time, sequence, interactions, etc.).

Upon a request/indication for help 304, in-app history 306 can be provided to contextual help system 308. The contextual help system can analyze a user's provided in-app history to determine (e.g., via a neural network) whether any help content are likely to resolve the user's in-app issues. At 310, it is determine if help content is found that is likely to resolve the user's in-app issue (e.g., the user's in-app history of events and previous in-app events are above a predetermined level of similarity indicating that the help content is above a threshold level of likelihood to resolve the user's issues). When help content 312 is determined as likely to resolve the user's issues, such content can be provided to the user for display via application 302. In embodiments, multiple solutions of help content can be determined as likely to resolve the user's issues. In such a case, the contextual help system can select help content determined to be most applicable (e.g., using a trained neural network updated based on user feedback of presented help content to degrade connections to help content indicated to be less applicable by a user; for instance, if help content 1-5 are provided and a user indicates 2 and 3 are most applicable, in future iterations, only 2 and 3 can be provided). The contextual help system can also provide all help content determined to be likely to resolve the user's issues.

When no help content is found at 310, in-app history 306 can be sent to live support system 314. While displayed as separate systems, it should be appreciated that the functionality provided by the live support system can be integrated into the contextual help system. The live support system can analyze the received in-app history of events leading up to, and, in some embodiments, including, the event of a user requesting/indicating help. This analysis of the in-app history of events can include using inverse language processing to turn the in-app history into a human readable sentence and/or paragraph that can be provided to a live support person. Advantageously, providing a human readable in-app history to a support person gives them a better idea of how to solve the user's in-app issues without the user needed to describe their issue allowing for more effective and efficient help to be provided. The live support person can be connected with the user to resolve the user's in-app issues. The live support person can help resolve the user's issue by providing a known or unknown solution based on the in-app history (e.g., determining help content exists that was provided to the user by the contextual help system for some reason, providing a solution to a previously undiagnosed issue).

When a live support person determines there is help content in the contextual help system that was not provided due to incorrect mapping, the live support person can indicate that the live support system should provide information to the contextual help system for further training. Such information provided to the contextual help system can allow the contextual help system to automatically provide the help content to users in the future when a user's in-app history is within the predetermined threshold of similarity. When there is no help content in the help system that are likely to resolve the user's issues with the application, the list of steps/the determined solution to the user's issue can be documented within the live support system. Such documentation can be written up in a manner that can be fed back into the contextual help system such that the contextual help system learns to provide that document when users run into a similar problem.

An example of using the illustrative environment for providing contextual help to users based on in-app event history leading up to request/indication for help in FIG. 3 is provided where the application/webpage is related to movies (e.g., FANDANGO®). Assume a user visits the main page, puts in their zip code, scrolls up and down that page 5 or 6 times, selects a movie and selects a time and then spends 5 minutes on the seat selection screen before contacting help. The events can be collected and stored, the events including: visiting main page, inputting zip code, scrolling up and down page 5/6 times, selecting a movie, selecting a time, spending 5 minutes on seat selection screen, and contacting help. These events can be analyzed by the contextual help system. For instance, the contextual help system could infer there is something wrong with the seat selection screen. One option is that maybe the page is not working correctly on the user's device. If this is the case, associated help content can be provided to the user. One way to determine whether this is the problem would be if the user's device is known to have a problem with displaying that page using a particular browser. In such a case, the help content provided to the user could be: “Try opening in a different browser.” Another option is that maybe the user is having a problem finding seats next to each other. In such a case, the help content provided to the user could be: “Try a movie at a different time if you are having trouble finding seats next to each other.”

A contextual help system can be specific to a particular company. For instance, each application with a separate mobile app can have its own automatic contextual help system that has been trained based on what help content the owner of the application has in existence. It should be appreciated that the contextual help system can include multiple systems hosted by one server for a variety of companies. However, in embodiments, even with multiple systems, the contextual help system can be trained individually to individually correspond to each company's individual application such that provided help content are still tailored to a particular company/application.

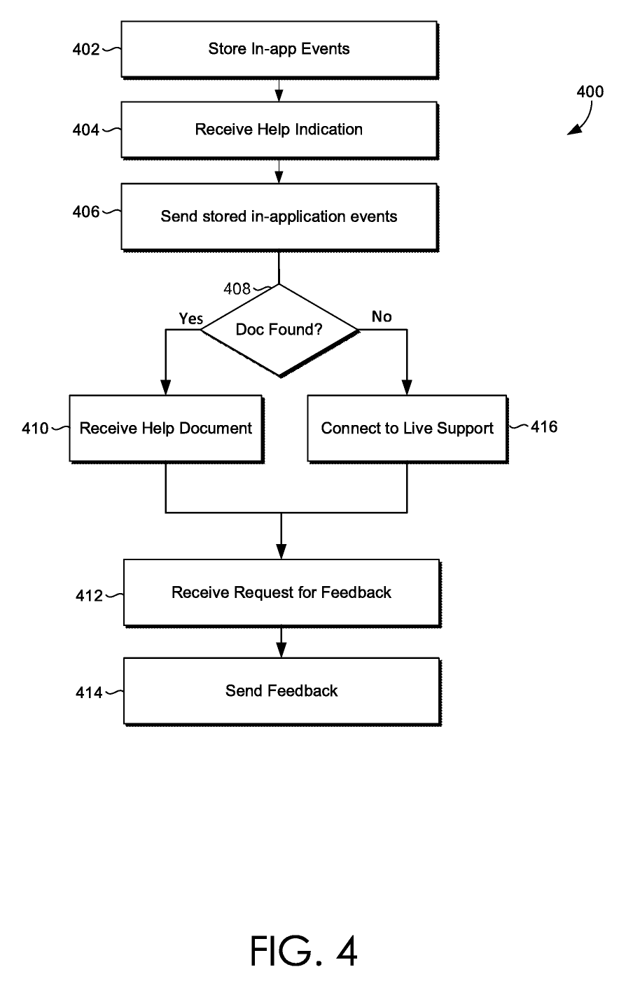

FIG. 4 illustrates a process flow 400 depicting an example of a request/indication for help with an in-app issue and providing help content based on an analysis of in-app history using a contextual help system, in accordance with embodiments of the present disclosure.

A user device can be utilized by a user to open and interact with an application (e.g., a mobile application). In one embodiment, as a user interacts with the application, at 402, in-app events are stored. In-app events can include analytics data collected by an analytics system. Such analytics data can define user behavior, information about user visits, etc. In-app events can be stored as a historical record of user interactions with an application. In-app events can be sorted and stored by time of occurrence so that the data can more easily be analyzed for causality/temporal relationships between events. In-app events can be stored on the user device such that in-app events can be quickly accessed and sent for analysis when a user requires help. Storing in-app events on the user device allows for even minor events to be stored such that, when help is requested/indicated, even minor events have been stored for analysis, presenting a more thorough snapshot of the events leading up to the request/indication for help.

At 404, a help indication is received. Such a help indication can be made by a user upon running into an issue with the application. Such an indication can be based on an interaction with a help button and/or automatically triggered based on a predefined list of occurrences (e.g., if a user's in-app events indicate that a user was browsing an application for jackets under $200 but stopped browsing after viewing delivery dated, a contextual help system can analyze the in-app history and provide “were you looking for a jacket under $200 that you would like to deliver a month from now? You might find them <here>”).

At block 406, stored in-app events can be sent to a contextual help system. In embodiments, such a contextual help system can be stored and run on a remote server. The in-app events sent to the contextual help system can be based on a pre-defined time prior to receiving the help indication. In some embodiments, the in-app event history sent is for 30 minutes leading up to the help indication. It should be appreciated other time sets can also be used (e.g., 2 minutes, 5 minutes, 10 minutes, 1 hour, 1 day, etc.). In other embodiments, the in-app history sent can be based on an entire application interaction session (e.g., where a session can be defined as one continuous or near continuous interaction with the application).

At block 408, when help content in found in the contextual help system, the help content can be received at 410. Upon receiving the help content, it can be displayed for the user. At block 412, a request for feedback regarding the provided help content can be received at a user device. At block 414, feedback can be sent back to the contextual help system. Feedback can take the form of a binary scale of usefulness (e.g., was the provided document helpful/did the provided link solve your issue). Feedback can also be in a multi-question form about the helpfulness of the help content. Such feedback can be used by the contextual help system to continually update.

At block 408, when help content cannot be found in the contextual help system, the user can be connected to live support at 416. Live support can analyze the user's in-app events and provide a known or unknown solution to resolve the user's in-app issues. At block 412, a request for feedback regarding the provided help can be received. At block 414, feedback can be sent back to the contextual help system.

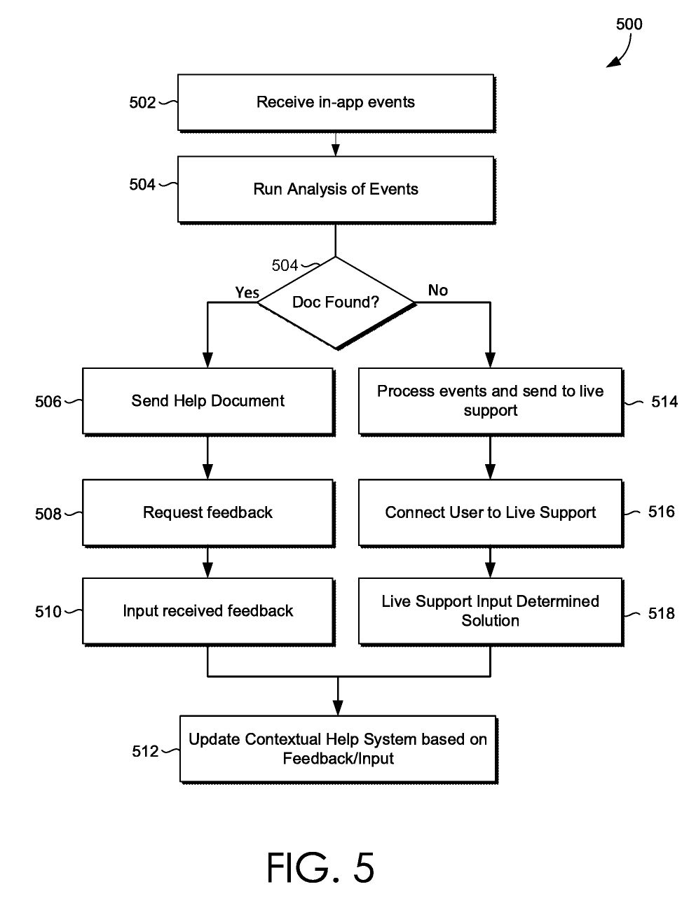

FIG. 5 illustrates a process flow 500 depicting an example of a contextual help system receiving a request for help with an in-app issue and providing help based on in-app history, in accordance with embodiments of the present invention.

At block 502, a contextual help system can receive in-app events related to a user operating an application. In embodiments, such in-app events can be sent automatically upon detecting a user needs help with an application. Further, in-app events can be received for a specified time period.

The contextual help system can run an analysis of the received in-app events at block 504. The analysis can determine if there is pre-existing help content and/or document location associated with a similar event history. A similar event history may occur when a previous event history and in-app events of a particular user exceed a predefined threshold of similar and/or the same events. The threshold of similarity can be set based on how closely a user's in-app history mirrors an in-app history linked to particular help content being likely to solve an issue (e.g., same/similar events, event order, duration, etc.).

At block 504, if help content is found by the contextual help system, at block 506, the help content can be sent to the user device the help indication originated from. At block 508, a request for feedback can also be sent to the user device. Such a request for feedback allows the user to provide input regarding the effectiveness of the help content sent to the user device. At block 510, feedback received can be input into the contextual help system. Inputting feedback regarding help content provided based on an analysis of in-app events leading up to an issue allows the contextual system to be updated based on the feedback.

At block 504, if no help content is found by the contextual help system, at block 514, in-app events can be processed and sent to live support. The processing of the in-app events can be performed using, for example, inverse language processing. In this way, a history of in-app events can be processed into a human readable sentence and/or paragraph. This human readable sentence/paragraph can be provided to a live support person to determine what issue a user has run into with the application.

At block 516, the contextual help system can connect a user to live support. The live support person can use the processed in-app events, provided at block 514, to guide the user to a solution of the in-app issue. The live support person can resolve the user's in-app issues by providing a known or unknown solution based on the in-app history. Such a solution can be when a live support person determines there is help content in the contextual help system that was not provided due to incorrect mapping. When there is no help content in the help system that are likely to resolve the user's issues with the application, the live support can guide the user through a list of steps/a determined solution to solve the user's in-app issue.

At block 518, live support can input the determined solution such that the contextual help system is updated based on the input. For instance, the live support person can indicate that the contextual help system should automatically provide help content to users in the future when a user's in-app history is within the predetermined threshold of similarity to the user's in-app history just reviewed. When there is no help content in the help system that are likely to resolve the user's issues with the application, the list of steps/the determined solution to the user's issue can be documented and used to update the contextual system.

Having described embodiments of the present invention, FIG. 6 provides an example of a computing device in which embodiments of the present invention may be employed. Computing device 600 includes bus 610 that directly or indirectly couples the following devices: memory 612, one or more processors 614, one or more presentation components 616, input/output (I/O) ports 618, input/output components 620, and illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 6 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 612 includes computer storage media in the form of volatile and/or nonvolatile memory. As depicted, memory 612 includes instructions 624. Instructions 624, when executed by processor(s) 614 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 600. Computing device 600 may be equipped with depth cameras, such as stereoscopic camera systems, infrared camera systems, RGB camera systems, and combinations of these, for gesture detection and recognition. Additionally, computing device 600 may be equipped with accelerometers or gyroscopes that enable detection of motion. The output of the accelerometers or gyroscopes may be provided to the display of computing device 600 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A computer-implemented method comprising:
receiving an in-app event history, the in-app event history including data associated with user interactions with an application that lead up to an in-app issue;
analyzing, by one or more processors running a contextual help system, the in-app event history based on previous event histories used to train the contextual help system, the contextual help system trained to determine help content likely to resolve in-app issues;
determining, using the analysis by the contextual help system, applicable help content likely to resolve the in-app issue, the applicable help content related to a previous event history having a threshold of similarity of event data with the in-app event history; and
providing the applicable help content based on the analysis in-app event history.

2. The computer-implemented method of claim 2, the method further comprising:
requesting feedback regarding the accuracy of the applicable help content in resolving the in-app issue; and
updating the contextual help system based on the feedback, in-app event history, and the provided help content.

3. The computer-implemented method of claim 1, the method further comprising:
determining no help content is likely to resolve the in-app issue;
converting the in-app event history into a human-readable form;
providing the human readable form of the in-app event history to a live-service desk; and
updating the contextual help system based on a solution determined by the live-service desk.

4. The computer-implemented method of claim 3, the method further comprising:
determining a known solution exists based on the in-app event history, the known solution being preexisting help content likely to resolve the in-app issue.

5. The computer-implemented method of claim 4, wherein the updating of the contextual help system is based on the known solution being correlated with the in-app event history.

6. The computer-implemented method of claim 3, the method further comprising:
determining an unknown solution based on the in-app event history, the unknown solution being a new issue encountered by the contextual help system.

7. The computer-implemented method of claim 1, the method further comprising:
training the contextual help system using the previous in-app event histories and corresponding help content known to resolve in-app issues associated with the previous in-app event histories; and
updating the contextual help system based on user feedback.

8. A non-transitory computer-readable storage medium including instructions which, when executed by a computer, cause the computer to perform operations comprising:
receiving an indication for help with an in-app issue;
determining an in-app event history to send to a contextual help system, the contextual help system trained to determine help content likely to resolve in-app issues;
sending the in-app event history to the contextual help system, wherein the contextual help system analyzes the in-app event history based on previous event histories to determine applicable help content likely to resolve the in-app issue; and
receiving the applicable help content from the contextual help system, wherein the applicable help content is related to a previous event history having a threshold of similarity of event data with the in-app event history.

9. The non-transitory computer-readable storage medium of claim 8, further comprising:
collecting in-app events; and
storing the in-app events, the in-app events stored for a predefined time.

10. The non-transitory computer-readable storage medium of claim 9, wherein the in-app event history comprises one or more stored in-app events.

11. The non-transitory computer-readable storage medium of claim 9, wherein the in-app events are stored based on time of occurrence.

12. The non-transitory computer-readable storage medium of claim 8, wherein the indication for help is automatically triggered based on an occurrence of one of a predefined list.

13. The non-transitory computer-readable storage medium of claim 8, wherein the indication for help is based on a user interaction with a help button.

14. The non-transitory computer-readable storage medium of claim 8, further comprising:
providing feedback to the contextual help system, the feedback indicating the accuracy of the applicable help content in resolving the in-app issue.

15. A computing system comprising:
one or more processors; and
one or more non-transitory computer-readable storage media, coupled with the one or more processors, having instructions stored thereon, which, when executed by the one or more processors, cause the computing system to provide:
means for determining help content related to an in-app issue using a sequence of in-app events leading up to the occurrence of the in-app issue;
means for providing live support when no help content is likely to resolve the in-app issue, the live support provided using the sequence of in-app events converted into a human readable form;
means for training a system capable of performing the determination of the help content and providing the live support.

16. The computing system of claim 15, wherein the help content is determined by:
receiving the sequence of in-app events; and
analyzing the sequence of in-app events to evaluate the help content likely to resolve the in-app issue by comparing similarity between previous in-app sequences and the sequence of in-app events.

17. The computing system of claim 16, wherein the help content is related to a previous in-app sequence having a threshold of similarity of event data with the sequence of in-app events.

18. The computing system of claim 15, wherein the live support is provided by:
determining no help content is likely to resolve the in-app issue; and
providing the human readable form to a live-service desk.

19. The computing system of claim 15, wherein the training is performed using feedback from users regarding a provided help content.

20. The computing system of claim 15, wherein the training is performed using a solution determined by a live service desk.
